(19) United States
(12) Patent Application Publication
(10) Pub. No.: US 2026/0046917 A1
(43) Pub. Date: Feb. 12, 2026

(54) MEASUREMENT-BASED CARRIER SELECTION IN MULTICARRIER SIDELINK

(71) Applicant: InterDigital Patent Holdings, Inc., Wilmington, DE (US)

(72) Inventors: Martino M. Freda, Laval (CA); Tuong Duc Hoang, Montreal (CA); Faris Alfarhan, Montreal (CA); Tao Deng, New York, NY (US)

(73) Assignee: InterDigital Patent Holdings, Inc., Wilmington, DE (US)

(21) Appl. No.: 19/101,312

(22) PCT Filed: Aug. 4, 2023
(86) PCT No.: PCT/US2023/029509

§ 371 Date: Feb. 5, 2025

Related U.S. Application Data
(60) Provisional application No. 63/395,475, filed on Aug. 5, 2022.

(51) Int. Cl. H04W 72/566; H04L 5/00

(52) U.S. Cl. CPC H04W 72/566; H04L 5/0048

(57) ABSTRACT

A wireless transmit and receive unit (WTRU) may be configured to prioritize carriers having available sensing results from inter-UE coordination (IUC) during carrier selection and logical channel prioritization (LCP). A WTRU may be configured to identify a carrier and to determine that the carrier has associated IUC information which may comprise sensing measurements. The WTRU may select the carrier from a plurality of carriers based on the carrier having the associated IUC information. The WTRU may prioritize selection of the carrier over other carriers in the selection based on the IUC information associated with the carrier. The WTRU may associate, based on the IUC information associated with the carrier, a first CBR threshold with the carrier. The WTRU may select data for transmission based on the first CBR threshold associated with the carrier.

### CROSS-REFERENCE TO RELATED APPLICATIONS

This application claims the benefit of Provisional U.S. Patent Application No. 63/395,475, filed Aug. 5, 2022, the disclosure of which is incorporated herein by reference in its entirety.

### BACKGROUND

Mobile communications using wireless communication continue to evolve. A fifth generation may be referred to as 5G. A previous (legacy) generation of mobile communication may be, for example, fourth generation (4G) long term evolution (LTE).

### SUMMARY

Systems, methods, and instrumentalities are disclosed for measurement-based carrier selection.

A wireless transmit and receive unit (WTRU) may identify a first carrier and a second carrier and may receive Inter-UE Coordination (IUC) information that may be associated with one of the carriers. The WTRU may receive data for transmission wherein the data may have an associated data priority. On a condition that the WTRU determines the data priority is above a priority threshold and the first carrier is associated with the IUC information, the WTRU may determine that a first channel busy ratio (CBR) associated with the first carrier satisfies a first CBR threshold, and may determine the first carrier is available to be selected.

On a condition that the WTRU determines that the data priority is above the priority threshold and the second carrier is not associated with IUC information, the WTRU may determine that a second CBR associated with the second carrier satisfies a second CBR threshold, and may determine the second carrier is available to be selected. The first CBR threshold may be higher than the second CBR threshold.

The WTRU may select a sidelink grant on the first carrier. On a condition that the WTRU determines that the first CBR associated with the first carrier is above the second CBR threshold, the WTRU may select for transmission on the first carrier data associated with a data priority above the priority threshold. On a condition that the WTRU determines that the first CBR associated with the first carrier is not above the second CBR threshold, the WTRU may select for transmission on the first carrier data from a highest priority channel. The WTRU may send the selected data using the sidelink grant on the first carrier.

The WTRU may determine a third carrier is associated with IUC information and a fourth carrier is not associated with IUC information. The WTRU may receive second data having an associated second data priority. On a condition that the WTRU determines that the second data priority is below the priority threshold, the WTRU may determine, based on a third CBR associated with the third carrier satisfying the second CBR threshold, that the third carrier is available to be selected. The WTRU may determine, based on a fourth CBR associated with the fourth carrier satisfying the second CBR threshold, that the fourth carrier is available to be selected. The WTRU may select a sidelink grant on the third carrier and may send data of any priority on the third carrier.

A WTRU may be configured to prioritize carriers having available sensing results from IUC during carrier selection and logical channel prioritization (LCP). A WTRU may be configured to identify a carrier and to determine that the carrier has associated IUC information which may comprise sensing measurements. The WTRU may select the carrier from a plurality of carriers based on the carrier having the associated IUC information. The WTRU may prioritize selection of the carrier over other carriers in the selection based on the IUC information associated with the carrier.

A WTRU may operate in autonomous resource allocation mode, e.g., mode 2. The WTRU may receive new data on a logical channel. In response to receiving the data, the WTRU may trigger carrier and resource reselection for a new HARQ process. The WTRU may determine whether it has received, e.g., recently received, IUC containing a set of preferred/non-preferred resources for one or more carriers.

The WTRU may determine a priority associated with the newly received data. If the WTRU determines the priority of the data may be above a threshold, the WTRU may determine to use a different (e.g., higher) CBR threshold for carrier selection with respect to a carrier for which IUC information may be available as compared to a carrier for which IUC information may not be available. If the WTRU determines the priority of the data may not be above the threshold, the WTRU may determine to use a single, e.g., the same, CBR threshold for carrier selection for both carriers for which IUC information may be available and for carriers for which IUC information may not be available.

The WTRU may be configured to select one or more allowed carriers, starting with the carriers where IUC information may be available, and thereafter in order of increasing CBR level. The WTRU may first select carriers having associated IUC information.

The WTRU may be configured to select a sidelink grant on a selected carrier. The WTRU may be configured to determine if the grant occurs on a carrier with an associated CBR that may be higher than the threshold associated with carriers having no associated IUC information. If the grant occurs on a carrier with an associated CBR that may be higher than the threshold associated with carriers having no associated IUC information, the WTRU may select data from the highest priority logical channel with data available and whose priority may be above a threshold. If the WTRU determines the grant occurs on a carrier with an associated CBR that may not be higher than the threshold, the WTRU may determine to select data from the highest priority logical channel with data available.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 depicts an example implementation of carrier selection.

### DETAILED DESCRIPTION

A more detailed understanding may be had from the following description, given by way of example in conjunction with the accompanying drawings.

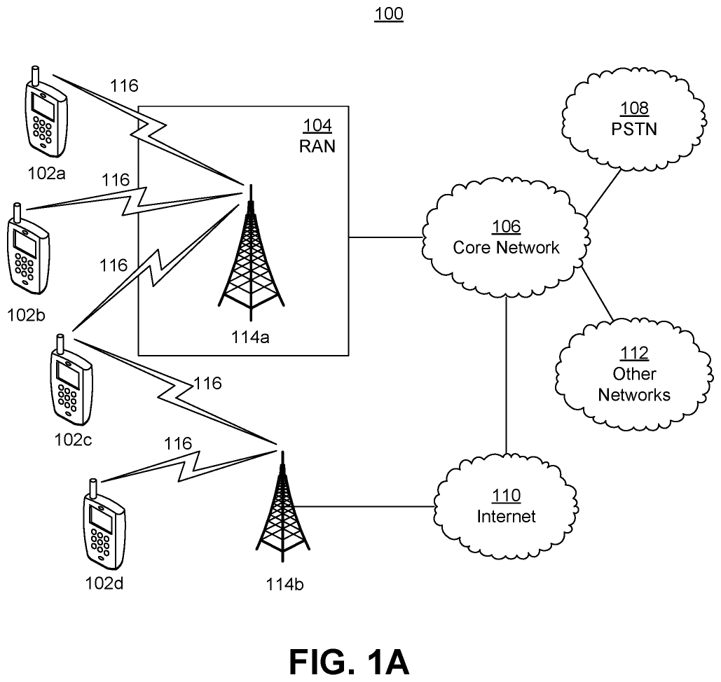

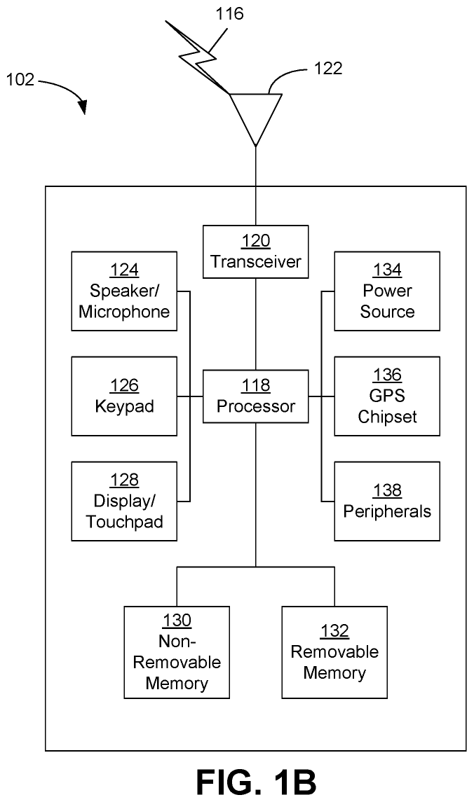

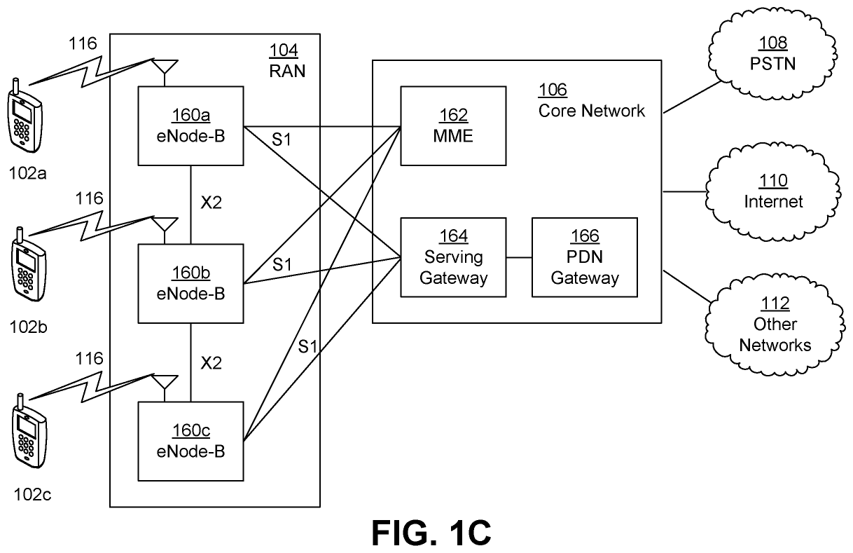

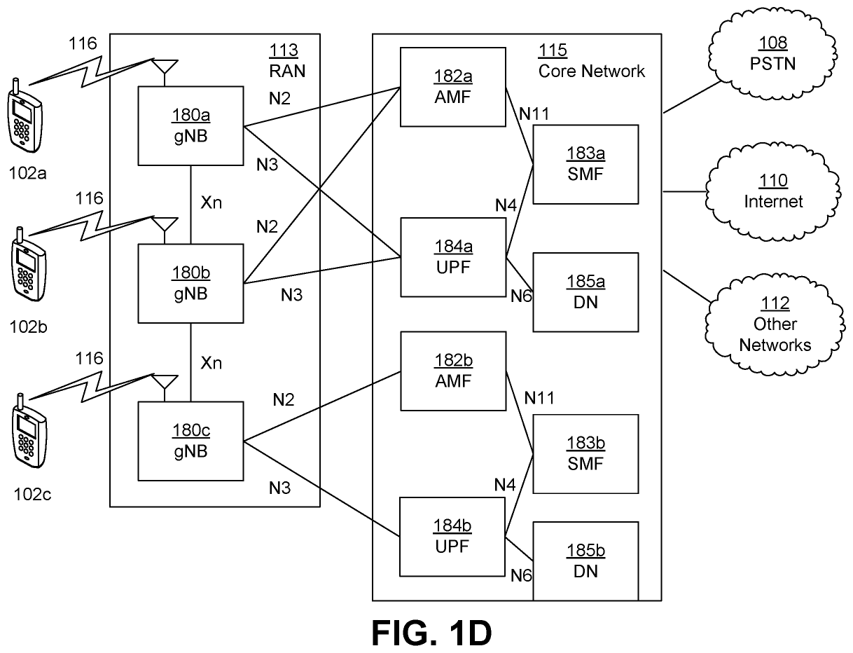

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform (DFT)-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c, and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B (eNB), a Home Node B, a Home eNode B, a gNode B (gNB), a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VolP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements is depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHZ, 80 MHZ, and/or 160 MHz wide channels. The 40 MHZ, and/or 80 MHZ, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHZ, 2 MHZ, 4 MHZ, 8 MHZ, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHZ, 4 MHZ, 8 MHZ, 16 MHz, and/or other channel bandwidth operating modes. Carrier sensing and/or Network Allocation Vector (NAV) settings may depend on the status of the primary channel. If the primary channel is busy, for example, due to a STA (which supports (e.g., only supports) a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may perform testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

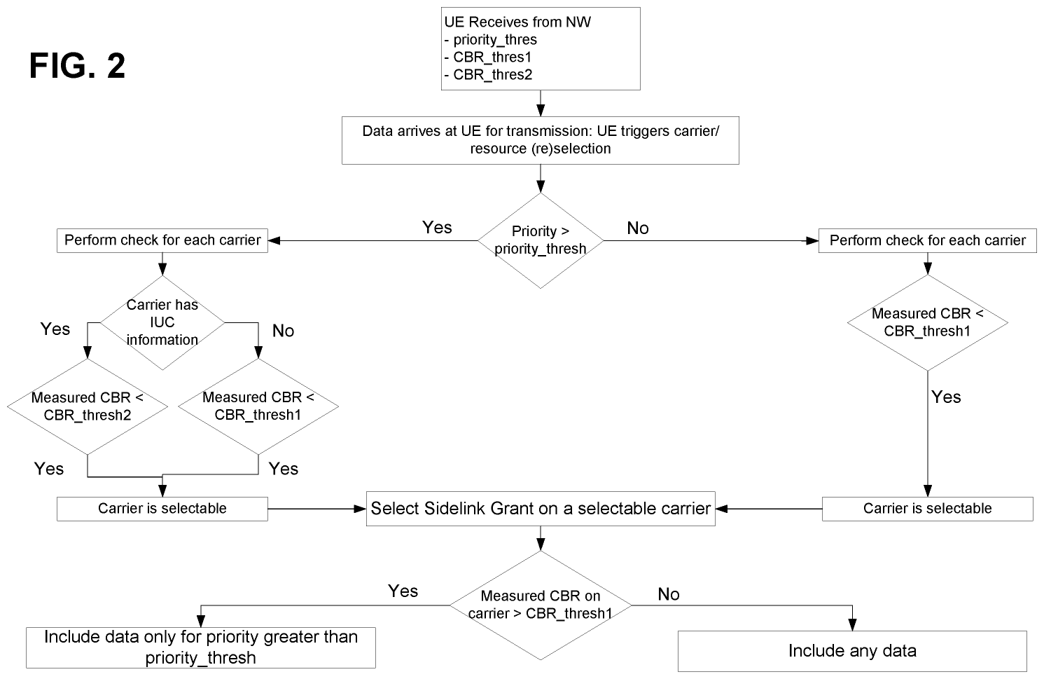

The present application discloses measurement-based carrier selection in multicarrier sidelink. The carrier selection may be applicable to new radio (NR) vehicle to everything (V2X) communications. A wireless transmit and receive unit (WTRU) may be configured to prioritize carriers with available sensing results from inter-UE coordination (IUC) during carrier selection, e.g., FIG. 2, and logical channel prioritization (LCP). A WTRU may be configured to identify a carrier and to determine that the carrier has associated IUC information which may comprise sensing measurements. The WTRU may select the carrier from a plurality of carriers based on the carrier having the associated IUC information. The WTRU may prioritize selection of the carrier over other carriers in the selection based on the IUC information associated with the carrier. The WTRU may associate, based on the IUC information associated with the carrier, a first CBR threshold with the carrier. The WTRU may select a logical channel and data for transmission from the logical channel based on the first CBR threshold associated with the carrier.

A WTRU may receive data for transmission wherein the data may have an associated data priority. On a condition that the WTRU determines the data priority is above a priority threshold and a first carrier is associated with the IUC information, the WTRU may determine that a first channel busy ratio (CBR) associated with the first carrier satisfies a first CBR threshold, and may determine the first carrier is available to be selected. On a condition that the WTRU determines that the data priority is above the priority threshold and the second carrier is not associated with IUC information, the WTRU may determine that a second CBR associated with the second carrier satisfies a second CBR threshold, and may determine the second carrier is available to be selected. The first CBR threshold may be higher than the second CBR threshold. The WTRU may select a sidelink grant on the first carrier. On a condition that the WTRU determines that the first CBR associated with the first carrier is above the second CBR threshold, the WTRU may select for transmission on the first carrier data associated with a data priority above the priority threshold. On a condition that the WTRU determines that the first CBR associated with the first carrier is not above the second CBR threshold, the WTRU may select for transmission on the first carrier data from a highest priority channel. The WTRU may send the selected data using the sidelink grant on the first carrier.

Vehicular communication may be a mode of communication whereby WTRUs may communicate with each other (e.g., directly communicate with each other). Two scenarios for V2X operations may comprise the following: an in-coverage scenario; and an out of coverage scenario. With respect to an in-coverage scenario, WTRUs may receive assistance from the network to start transmitting and receiving V2X messages. With respect to an out of coverage scenario, WTRUs may use pre-configured parameters to start transmitting and receiving V2X messages.

V2X communication may relate to Device-to-Device (D2D) communications. V2X communication services may comprise (e.g., consist of) the following types (e.g., four different types): V2V (Vehicle to Vehicle); V21 (Vehicle to infrastructure); V2N (Vehicle to Network); and V2P (Vehicle to Pedestrian). V2V (Vehicle to Vehicle) communications may comprise vehicular WTRUs communicating with each other (e.g., communicating with each other directly). V2I (Vehicle to infrastructure) communications may comprise vehicular WTRUs communicating with RSUs/eNBs. V2N (Vehicle to Network) communications may comprise vehicular WTRUs communicating with a core network. V2P (Vehicle to Pedestrian) communications may comprise vehicular WTRUs communicating with WTRUs that may be associated with conditions, e.g., special conditions, such as, for example, low battery capacity.

V2X communication may involve resource allocation. LTE may define two modes of operation in V2X communication. A first mode may be Mode 3 wherein the network may give the WTRU a scheduling assignment for V2X sidelink transmission. A second mode may be Mode 4 wherein the WTRU may select (e.g., autonomously select) the resources from a configured/pre-configured resource pool. V2X LTE may define two categories of resource pools. A first category may comprise receiving pools which may be monitored for receiving V2X transmission. A second category may comprise V2X transmitting pools which may be used by WTRUs to select the transmission resource in Mode 4. Transmitting pools may or may not be used by WTRUs configured in Mode 3.

In LTE, the resource pools may be semi-statically signaled to WTRUs via RRC signaling. In Mode 4, the WTRU may use sensing before selecting a resource from the RRC configured transmitting pool. LTE V2X may or may not support dynamic resource pools reconfiguration; pool configuration may, e.g., may only, be carried via SIB and/or dedicated RRC signaling.

New Radio (NR) may provide V2X resource allocation. NR may have inherited two modes of resource allocation from LTE. Mode 1 resource allocation may correspond to gNB scheduled resource allocation. Mode 2 resource allocation may correspond to WTRU autonomous resource allocation. The concept of resource pools and sensing for mode 2 resource allocation may have also been inherited from LTE.

Multicarrier SL Transmission may be provided. Carrier aggregation (CA) in sidelink may be supported for V2X sidelink communication. It may apply to both in-coverage WTRUs and out-of-coverage WTRUs. For CA in sidelink, neither primary component carrier nor secondary component carriers may be defined. Each resource pool configured, e.g., (pre)configured, for V2X sidelink communication transmission or reception may be associated with a single carrier. If a WTRU supporting CA in sidelink uses autonomous resource selection, it may perform carrier selection and may select one or more carriers used for V2X sidelink communication transmission. The carrier selection may be performed at the MAC layer, depending on the CBR of the configured, e.g., (pre)configured, carriers for V2X sidelink communication and the PPPP(s) of the V2X messages to be transmitted. The carrier reselection may be performed when resource reselection may be triggered and may be triggered for each sidelink process. In order to avoid frequent switching across different carriers, the WTRU may continue using a carrier that may already be selected for transmission, if the measured CBR on this carrier may be lower than a (pre)configured threshold. Selected carriers, e.g., all selected carriers, may have the same synchronization reference or the same synchronization priority configuration. For a WTRU using autonomous resource selection, logical channel prioritization may be performed for a sidelink resource on a carrier depending on the CBR measured on the carrier and the PPPP of the sidelink logical channels.

In LTE, carrier aggregation may be supported for broadcast, e.g., broadcast only. The transmission carriers may be selected by the transmission WTRU based on the carriers configured by upper layers for the services (e.g., L2 ID) being transmitted, and by taking into account CBR to ensure equal usage of resources.

Selection in LTE may or may not consider some of the enhancements made for unicast and/or resource selection in NR. A TX WTRU may make use of (or rely on) IUC (inter UE coordination) information in performing resource selection. It may be possible that the TX WTRU may not have access to IUC in all of the available carriers. For a WTRU that may be unable to perform sensing in a carrier, availability of IUC may be considered for carrier selection. Measurements available in unicast (SL CQI, SL RSRP) may be used to avoid selecting inappropriate carriers for SL transmission.

Configurations for SL carrier aggregation may be provided. Carrier selection may be performed by a SL WTRU. A WTRU may employ criteria for carrier selection. A WTRU in mode 2 may perform carrier selection procedures. Carrier selection may comprise determining the allowable carriers for transmission of a particular or multiple L2 IDs. The WTRU may determine the actual carriers used for transmission of a particular or multiple L2 IDs at a given time. The WTRU may select the actual carriers for transmission from the set of allowable carriers. Selection of carriers may comprise determining the specific carriers that may be used for unicast versus the carriers which may be used for broadcast/groupcast. Selection may also comprise determining the amount of time in which one or a number of carriers may be used for transmission and selecting a set of carriers (e.g., a set of preferred carriers) to be sent to a peer WTRU (e.g., in a unicast link).

A WTRU in mode 2 may use one or a combination of the following criteria to select the carrier(s) for SL transmission: L2 ID; CBR; QoS and/or SLRB configuration; SL measurements reported by a peer WTRU; availability of and/or nature of sensing results which may be from IUC information; licensed carrier versus unlicensed carrier; LBT results on an unlicensed carrier; cast type; HARQ feedback; presence of PSFCH on a carrier; and/or presence of one or more resource pools configured on the carrier that satisfy a pool-specific criteria. In connection with L2ID, a WTRU may determine whether an L2 ID may be allowed to be used on a carrier based on information from upper layers.

CBR may be used as criteria to select the carrier(s) for SL transmission. A WTRU may determine whether a carrier may be allowed for transmission based on whether the measured CBR is above a priority dependent threshold. A WTRU may determine the specific carriers to be used for transmission by selecting, e.g., selecting first, the carriers with a particular CBR such as, for example, the lowest CBR or the highest CBR. Conditions for carrier selection may use CBR in conjunction with other factors. A WTRU may use one factor for selection under a first CBR condition, and another factor for selection under a second CBR condition. A WTRU may determine the CBR threshold to be used for selection based on the outcome of another condition, such as determining the number of carriers to select based on the CBR.

QoS and/or SLRB configuration may be used as criteria to select the carrier(s) for SL transmission. A WTRU may determine the CBR threshold for determining the allowed carriers based on the priority of data available for transmission. The specific carriers, the number of allowed carriers, the allowable CBR range for selection, the period of time in which a carrier may be kept before reselection is triggered, etc., may be configured in the SLRB configuration or may be determined based on a parameter associated with the SLRB configuration or the QoS flows mapped to the SLRB. Whether a criteria (e.g., availability of sensing results from IUC) for selection is applied or not may depend on the priority associated with the data available for transmission.

SL measurements reported by a peer WTRU may be used as criteria to select the carrier(s) for SL transmission. SL measurements may encompass measurements received, e.g., currently received, from a peer WTRU, such as, for example, SL RSRP, SL CQI, as well as other measurements which may be considered in the future. The WTRU may select the carriers with the highest SL RSRP from the set of allowed carriers. If the carrier may be currently being used for unicast and the SL RSRP reported may be above a threshold, the carrier may be kept regardless of the measured CBR on the carrier. If the carrier may be currently being used for unicast and the SL RSRP reported may be above a threshold, whether the carrier may be an allowed carrier or not may be determined by a different threshold compared to a carrier that may not be being used for unicast or may not have SL RSRP reported above a threshold.

Availability of and/or the nature of sensing results, possibly from IUC information, may be used as criteria to select the carrier(s) for SL transmission. A WTRU may select a carrier based on whether sensing results are available, where such sensing results may be obtained by the WTRU's own sensing, or may be obtained from sensing performed by other WTRUs (and sent in IUC information). A WTRU may select a carrier based on the nature of the sensing results available such as, for example, the following: whether the sensing results may be associated with partial sensing, short term partial sensing, periodic partial sensing, full sensing, etc, or other types of sensing which may represent the amount of resources sensed; whether the sensing may result from the WTRU itself, or may be received from another WTRU in IUC information;

whether the sensing results received from IUC information may be received as a result of a request, or may be received as a result of the peer WTRU transmitting the results autonomously; whether the sensing results may be associated with preferred resources, non preferred resources, or resources which may result in conflict (e.g., the type of IUC information sent); the number of WTRUs from which the TX WTRU may have received IUC information, possibly associated with a specific carrier; whether the IUC information may be received from a WTRU with which the TX WTRU may have a unicast link; and/or whether the IUC information may be received from a WTRU to which the TX WTRU may transmit to, possibly as a result of the carrier selection, or is selecting a carrier for in order to transmit to.

Licensed carrier versus unlicensed carrier may be used as criteria to select the carrier(s) for SL transmission. The WTRU may select a licensed carrier before an unlicensed carrier. The WTRU may select a licensed carrier based on a criteria if a first condition may be satisfied (e.g., CBR may be above a first threshold), and may select a licensed carrier based on a same or different criteria if a second condition may be satisfied (e.g., CBR may be above a second threshold). The WTRU may select a licensed carrier before an unlicensed carrier (or vice versa) based on whether some other condition/criteria may be satisfied (e.g., based on the priorities configured in one or more SLRBs, based on the whether the SLRB is configured to be prioritized on licensed or unlicensed, etc.)

LBT results on an unlicensed carrier may be used as criteria to select the carrier(s) for SL transmission. The WTRU may exclude a carrier from selection if LBT fails on the carrier, fails a number of times, and/or fails over a period of time. The WTRU may select a carrier based on the number of LBT failures on the carrier, possibly over a period of time.

Cast type may be used as criteria to select the carrier(s) for SL transmission. The WTRU may use a first criteria or condition associated with the criteria to determine that the carriers selected when data may be available for a first cast type and may use a second criteria or condition associated with the criteria to determine the carriers selected when data may be available for a second cast type.

HARQ feedback may be used as criteria to select the carrier(s) for SL transmission. The WTRU may select a carrier based on the ratio of ACK/NACK received on the carrier, possibly associated with a specific destination. If the WTRU may receive, e.g., receive consecutively and/or over a period of time, a number of NACK associated with a L2 ID on a carrier, it may select another carrier, possibly for that specific L2 ID. A WTRU may exclude a carrier from selection following reception, e.g., consecutively and/or over a period of time, of a number of NACK/DTX. Such exclusion may be maintained for a period of time.

Presence of PSFCH on a carrier may be used to select the carrier(s) for SL transmission. A WTRU may select or prioritize for selection a carrier with PSFCH resources configured if the WTRU may be configured with a unicast link and/or groupcast with HARQ feedback, or if the WTRU may have a logical channel configured with HARQ feedback enabled.

Presence of one or more resource pools configured on the carrier that satisfy a pool-specific criteria may be used to select the carrier(s) for SL transmission. The carrier may be selected/prioritized if at least one pool or all pools on the carrier meet the criteria.

The criteria noted herein as well as others may be used to prioritize certain carriers over other carriers, possibly in the selection triggered by availability of data for a specific destination, bearer, priority, etc. In the context of carrier selection, prioritization may consist of one or more of the following: in the event of equal selection criteria, the WTRU may select the prioritized carrier over the non-prioritized carrier; the WTRU may use a more relaxed condition (e.g., higher CBR threshold) when determining whether to exclude a carrier from the set of allowed carriers, the set of selected carriers, or the carrier used for transmission; the WTRU may include a larger number of carriers in its selected carrier list than the maximum allowable if the carriers may be prioritized; the WTRU may select, e.g., may first select, the prioritized carriers during carrier selection (possibly in an order defined by another criteria) before it considers non-prioritized carriers for selection. Example embodiments of the above criteria used in prioritization during carrier selection may be discussed herein.

Use of a carrier in a unicast link may result in prioritization of that carrier. A WTRU may prioritize selection of carriers which have been determined to be used, may be used, or are already in use for communication with a peer WTRU in a unicast link. A benefit of such processing may be that it may avoid the need for reconfiguration of the peer WTRU, which may possibly involve PC5-RRC signaling, and may have an impact on that WTRU's carrier selection as well.

The quality measured by a peer WTRU over a carrier in a unicast link may result in prioritization of that carrier. A WTRU may prioritize selection of carriers where the WTRU may have received a measurement (e.g., CQI) from a peer WTRU on that carrier, possibly where such measurement meets a criteria (e.g., the measurement may be above a threshold). A WTRU may prioritize selection of carriers where the number of reports, or the number of WTRUs reporting on the carrier, possibly with a measurement criteria being met, may be above a specific number. A benefit of such processing may be that more efficient usage of SL resources on carriers with higher CBR may be allowed.

The availability of sensing results received from IUC information for a carrier may result in prioritization of that carrier. A WTRU may prioritize selection of carriers where the WTRU may receive IUC information from another WTRU, may have recently received IUC information from another WTRU, and/or may request IUC information from another WTRU. A WTRU may be configured with a validity timer associated with received IUC information, and at resource selection, may prioritize carriers for which the WTRU may have valid IUC information associated with that carrier. A benefit of such processing may be that it may reduce the overall collision on sidelink by prioritizing the use of carriers where sensing results may be applied.

Selection or removal of a carrier may be prohibited for a period of time. Selection of a carrier or removal of a carrier, possibly after a carrier selection procedure, may be prohibited for a period of time. Following one of the triggers/conditions for selecting a carrier (e.g., HARQ NACK), the WTRU may maintain the selected carrier for at least a period of time. Such maintenance may further be contingent on other criteria herein being satisfied for the entire time period. Similarly, following exclusion of a carrier in carrier selection, the WTRU may continue to exclude the carrier for a period of time.

Selection and/or reselection of a carrier may be triggered. A WTRU may trigger a carrier (re)selection procedure at one or more in any combination (e.g., A as a condition of B, etc.) of the following events: events related to IUC; events related to reception of measurements from a peer WTRU; events related to unicast link establishment/maintenance; events related to HARQ feedback; events related to establishment/release of a new QoS flow and/or SLRB; events related to unlicensed operation; events related to a change in CBR; and events related to a change in SL DRX configuration or the Uu DRX configuration.

Events related to IUC may be used to trigger carrier selection and/or reselection. A WTRU may trigger carrier (re)selection when it receives IUC, possibly related to a carrier currently being used. A WTRU may trigger carrier (re)selection when the received IUC may be associated with a carrier for which it may not have IUC information. A WTRU may trigger carrier (re)selection when the validity of IUC information, possibly associated with a carrier, may have expired. A WTRU may trigger carrier (re)selection when it may not receive IUC information for a carrier (possibly at expiry of a timer associated with validity).

Events related to reception of measurements (e.g., CQI, RSRP) from a peer WTRU, possibly associated with some conditions on those measurements, may be used to trigger carrier (re)selection. A WTRU may trigger carrier (re)selection when it receives a CQI report from a peer WTRU, possibly with a CQI value above or below a threshold.

Events related to unicast link establishment/maintenance may be used to trigger carrier (re)selection. A WTRU may trigger carrier (re)selection following the establishment or release of a unicast link with a peer WTRU. A WTRU may trigger carrier (re)selection following reception of a sidelink reconfiguration message from a peer WTRU, possibly (re)configuring a set of carriers. A WTRU may trigger carrier (re)selection following successful application of a sidelink reconfiguration received from a peer WTRU. A WTRU may trigger carrier (re)selection following transmission/reception of a reconfiguration success/failure message. A WTRU may trigger carrier (re)selection following detection of SL-RLF with a peer WTRU.

Events related to HARQ feedback may be used to trigger carrier (re)selection. A WTRU may trigger carrier (re)selection following reception (possibly consecutive and/or possibly occurring within a period of time) of one or more of HARQ NACK and/or HARQ DTX from a peer WTRU.

Events related to establishment/release of a new QoS flow and/or SLRB may be used to trigger carrier (re)selection. A WTRU may trigger carrier (re)selection following establishment of a new SLRB, if such establishment/release may result in a change in the selected carriers based on carrier selection criteria herein.

Events related to unlicensed operation may be used to trigger carrier (re)selection. A WTRU may trigger carrier (re)selection following one or more LBT failures on the carrier.

Events related to a change in CBR may be used to trigger carrier (re)selection. A WTRU may trigger carrier (re)selection following a change in the measured CBR, possibly for a specific carrier, possibly by a certain amount.

Events related to a change in SL DRX configuration or the Uu DRX configuration may be used to trigger carrier (re)selection. A WTRU may trigger carrier (re)selection following a change in the SL DRX configuration, possibly between two WTRUs.

LCP may take into account the criteria that were used for carrier selection. A WTRU may be configured with an LCP restriction associated with a mapping of data on a logical channel to a specific carrier. The conditions associated with applying such LCP restriction may be related to the criteria that was applied for the carrier selection. For example, a grant on a carrier may be used, e.g., may only be used, for a specific logical channel if the carrier may have been selected due to the presence of data available from that logical channel. If a condition for selecting a carrier may have been met for carrier selection due to the presence of data from a logical channel, the WTRU may multiplex data, e.g., only data, associated with that logical channel onto the grants of the associated selected carrier. If a WTRU prioritizes one carrier over another carrier for a specific logical channel, data, e.g., only data, from that specific logical channel may be mapped to the prioritized carrier. If a condition for selecting a carrier may have been met for carrier selection due to the presence of data from a logical channel, the WTRU may multiplex data, e.g., only data, associated with that logical channel onto grants if the carrier meets the same condition. If a condition may have been met for carrier selection due to the presence of data from a logical channel and may not be met if data was not present on the said logical channel, if a carrier may have satisfied the condition for the presence of the logical channel and may not satisfy the condition for non-presence of the logical channel, the WTRU may, e.g., may only, multiplex data associated with the logical channel onto that carrier.

If a WTRU may have data available for SLRB with priority above a priority threshold, the WTRU may use a first CBR threshold (e.g., may select the carrier if the measured CBR is below a first threshold) for carriers in which the WTRU may have sensing results from another WTRU, and may use a second CBR threshold (e.g., may select the carrier if the measured CBR is below a second threshold) for carriers in which the WTRU may not have sensing results from another WTRU, e.g., FIG. 2. In such case, when a WTRU selects/receives a grant associated with a carrier having a CBR that may be below the first threshold, but above the second threshold, the WTRU may multiplex data, e.g., only data, associated with the logical channels with priority above the priority threshold.

A wireless transmit and receive unit (WTRU) may comprise a processor configured to: identify a first carrier in a plurality of carriers; determine inter-UE coordination (IUC) information is associated with the first carrier; and select the first carrier from a plurality of carriers based on the IUC information. The processor configured to select the first carrier from a plurality of carriers based on the IUC information may be configured to prioritize the carrier based on the IUC information. The processor may be further configured to: determine a second carrier in the plurality of carriers; receive data, the data having an associated priority; and on a condition the associated priority is above a threshold, associate, based on the IUC associated with first carrier, a first CBR threshold with the first carrier; and associate a second CBR threshold with the second carrier. The first CBR threshold may be higher than the second CBR threshold. The processor configured to select the first carrier from a plurality of carriers may be configured to select the first carrier based on the IUC information and the first CBR threshold. The processor may be further configured to: select a sidelink grant on the first carrier; select, based on the first CBR threshold associated with the first carrier, data having a priority; and send the data on the first carrier.

A WTRU may use a first CBR threshold for selection of the carrier if the WTRU may use the carrier to transmit unicast data and may use a second CBR threshold otherwise. If the WTRU selects a grant on a carrier for which the CBR on the carrier meets the condition for selection in the case of unicast but does not meet the condition for selection in the case of broadcast/groupcast, the WTRU may select unicast data for transmission on the grant/carrier. If conditions for both unicast and groupcast are met on the carrier, the WTRU may not apply LCP restriction.

A WTRU in unicast may select or be assigned a primary carrier. A WTRU with a unicast link may select, or be assigned (e.g., by the peer WTRU, by the network, etc.) a primary carrier when multiple carriers are configured/used between the WTRUs. The WTRU may use the criteria herein to select the primary carrier from the set of carriers used for transmission of data on the unicast link. For example, the WTRU may select the carrier with the smallest CBR to be the primary carrier. The WTRU may select the carrier with the best CQI to be the primary carrier. The WTRU may select the carrier with the largest number of sensing results received from other WTRUs.

A WTRU may use the primary carrier to perform, for example, the following associated with a unicast link: transmission of PC5-RRC signaling; transmission of PC5-S signaling; use of the primary carrier when a condition occurs in which a single carrier, e.g., only a single carrier, may be used (e.g., average CBR over all carriers is above a threshold); the WTRU may use the primary carrier's CBR as a representation of the CBR of the carriers associated with a unicast link; transmission of IUC information may be made on the primary carrier; and/or IUC information may be provided to the peer WTRU for the primary carrier.

A WTRU may use the same carrier as may be used by the peer WTRU as its primary carrier. The WTRU may be assigned the primary carrier by a peer WTRU. A WTRU may (re)select a primary carrier when it performs carrier (re)selection procedure. The WTRU may, e.g., may alternatively, be configured with separate triggers (e.g., different than carrier (re)selection) for determination of the primary carrier.

Although features and elements described herein are described in particular combinations, each feature or element may be used alone without the other features and elements of the preferred embodiments, or in various combinations with or without other features and elements.

The description herein may be provided for exemplary purposes and does not limit in any way the applicability of the described systems, methods, and instrumentalities to other wireless technologies and/or to wireless technology using different principles, when applicable. The term network in this disclosure may refer to one or more gNBs which in turn may be associated with one or more Transmission/Reception Points (TRPs) or any other node in the radio access network.

Although the implementations described herein may consider 3GPP specific protocols, it is understood that the implementations described herein are not restricted to this scenario and may be applicable to other wireless systems. For example, although the solutions described herein consider LTE, LTE-A, New Radio (NR) or 5G specific protocols, it is understood that the solutions described herein are not restricted to this scenario and are applicable to other wireless systems as well.

The processes described herein may be implemented in a computer program, software, and/or firmware incorporated in a computer-readable medium for execution by a computer and/or processor. Examples of computer-readable media include, but are not limited to, electronic signals (transmitted over wired and/or wireless connections) and/or computer-readable storage media. Examples of computer-readable storage media include, but are not limited to, a read only memory (ROM), a random access memory (RAM), a register, cache memory, semiconductor memory devices, magnetic media such as, but not limited to, internal hard disks and removable disks, magneto-optical media, and/or optical media such as compact disc (CD)-ROM disks, and/or digital versatile disks (DVDs). A processor in association with software may be used to implement a radio frequency transceiver for use in a WTRU, terminal, base station, RNC, and/or any host computer.

1-21. (canceled)

22. A wireless transmit and receive unit (WTRU) comprising:
a processor configured to:
establish a unicast link with a peer WTRU;
determine a plurality of carriers adapted for communication with the peer WTRU;
receive from the peer WTRU an indication of a carrier in the plurality of carriers; and
transmit inter-UE coordination (IUC) information on the carrier in the plurality of carriers.

23. The WTRU of claim 22,
wherein the carrier in the plurality of carriers is a primary carrier.

24. The WTRU of claim 22,
wherein the indication of the carrier in the plurality of carriers comprises an assignment of the carrier in the plurality of carriers.

25. The WTRU of claim 22,
wherein the indication of the carrier in the plurality of carriers comprises an indication that the peer WTRU uses the carrier.

26. The WTRU of claim 25,
wherein the indication that the peer WTRU uses the carrier comprises an indication that the peer WTRU uses the carrier as a primary carrier.

27. The WTRU of claim 22, wherein the IUC information is associated with the carrier.

28. The WTRU of claim 22,
wherein the processor is further configured to send sidelink communications on the carrier.

29. The WTRU of claim 22,
wherein the processor is further configured to transmit on the carrier one or more of RRC signaling or PC5-S signaling.

30. The WTRU of claim 22,
wherein the processor is further configured to send communications on the carrier in the plurality of carriers on a condition a single carrier is permitted to be used.

31. The WTRU of claim 30,
wherein the single carrier is permitted to be used if an average channel busy ratio (CBR) for the plurality of carriers is above a threshold.

32. A method of communicating, comprising:
establishing a unicast link with a peer WTRU;
determining a plurality of carriers adapted for communication with the peer WTRU;
receiving from the peer WTRU an indication of a carrier in the plurality of carriers; and
transmitting inter-UE coordination (IUC) information on the carrier in the plurality of carriers.

33. The method of claim 32,
wherein the carrier in the plurality of carriers is a primary carrier.

34. The method of claim 32,
wherein the indication of the carrier in the plurality of carriers comprises an assignment of the carrier in the plurality of carriers.

35. The method of claim 32,
wherein the indication of the carrier in the plurality of carriers comprises an indication that the peer WTRU uses the carrier.

36. The method of claim 35,
wherein the indication that the peer WTRU uses the carrier comprises an indication that the peer WTRU uses the carrier as a primary carrier.

37. The method of claim 32, wherein the IUC information is associated with the carrier.

38. The method of claim 32, further comprising:
sending sidelink communications on the carrier.

39. The method of claim 32, further comprising:
transmitting on the carrier one or more of RRC signaling or PC5-S signaling.

40. The method of claim 32, further comprising:
sending communications on the carrier in the plurality of carriers on a condition a single carrier is permitted to be used.

41. The method of claim 40,
wherein the single carrier is permitted to be used if an average channel busy ratio (CBR) for the plurality of carriers is above a threshold.
